(19) United States
(12) Patent Application Publication
(10) Pub. No.: US 2012/0224246 A1
(43) Pub. Date: Sep. 6, 2012

(54) GRATING STRUCTURE OF 2D/3D SWITCHING DISPLAY DEVICE

(75) Inventors: YU-CHOU YEH, TAOYUAN COUNTY (TW); CHAO-YI WANG, TAOYUAN COUNTY (TW); WEN-CHIH LO, TAOYUAN COUNTY (TW); CHI-HSIEN SUNG, TAOYUAN COUNTY (TW); TSUNG-HER YEH, TAIPEI COUNTY (TW)

(73) Assignee: J TOUCH CORPORATION, TAOYUAN COUNTY (TW)

(21) Appl. No.: 13/085,627

(22) Filed: Apr. 13, 2011

(30) Foreign Application Priority Data
Mar. 4, 2011 (TW) 100107339

(51) Int. Cl. G02F 1/15

(52) U.S. Cl. 359/265

(57) ABSTRACT

A grating structure of a 2D/3D switching display device comprises: a first transparent substrate, a first transparent conductive film; a second transparent substrate, and a second transparent conductive film disposed with an interval apart with each other on a side of the first transparent conductive film, such that a potential difference is produced between the first transparent conductive film and the second transparent conductive film; a solution type electrochromic material, disposed between the two transparent conductive films; an isolating element, made of an inorganic material, and disposed on a side of the second transparent conductive film; and a conductive wire layer, disposed on a lateral periphery of the first transparent conductive film and/or the second transparent conductive film. After the conductive wire layer is electrically conducted, the conductive wire layer with a low resistance accelerates the conduction of current, so as to improve the efficiency and uniformity of coloration.

### CROSS-REFERENCE TO RELATED APPLICATIONS

This non-provisional application claims priority under 35 U.S.C. §119(a) on Patent Application No(s). 100107339 filed in Taiwan, R.O.C. on Mar. 4, 2011, the entire contents of which are hereby incorporated by reference.

### BACKGROUND OF THE INVENTION

2. Field of the Invention

The present invention relates to the field of display devices, and more particularly to a grating structure of a 2D/3D switching display device having a frame made of a metal conductive wire for accelerating the conduction speed of current of a transparent conductive film to enhance the efficiency and uniformity of coloration.

3. Description of the Prior Art

In general, the principle of 3D image display technology adopts binocular disparity, such that a viewer's left and right eyes can receive different images respectively, and finally the viewer's brain merges the images into a 3D image. As to the naked-eye 3D display technology, the structure of the 3D image display device for switching the display of 3D images and 2D images is mainly divided into two types, respectively: lenticular and barrier, and both designs using an electrochromic material to achieve the barrier effect.

As disclosed in R.O.C. Pat. No. M368088 entitled “Integrated electrochromic 2D/3D display device, R.O.C. Pat. No. M371902 entitled “Display device for switching 2D image/3D image display screen”, R.O.C. Pat. No. 1296723 entitled “Color filter used for 3D image LCD panel manufacturing method thereof”, and U.S. Pat. Application No. 2006087499 entitled “Autostereoscopic 3D display device and fabrication method thereof”, electrochromic materials are used as a parallax barrier device for displaying 3D images, the electrochromic materials use the effect of a current or an electric field to absorb light or disperse light, such that the color of the electrochromic material can have a reversible change.

After the electrochromic materials of this sort are combined appropriately, a grating structure for switching the 2D/3D display is formed. With reference to FIG. 1 for a schematic view of a grating structure, the grating structure 1 comprises a first substrate 11, a second substrate 12, an electrochromic layer 13 and an electrolyte layer 14, wherein the first substrate 11 includes a first transparent conductive film 111 disposed at an upper surface of the first substrate 11 and a second transparent conductive film 121 disposed at a lower surface of the second substrate 12, and the electrochromic layer 13 and the electrolyte layer 14 are included between the first substrate 11 and the second substrate 12. The electrochromic layer 13 is made of an inorganic solid film selected from the collection of an oxide, a hydroxide, and a derivative of a transition element, or a composite material made by mixing the inorganic solid film with an organic compound/electrolyte material such as WO₃, Ni(OH) ₂, and Prussian blue, etc, and the electrolyte layer 14 is mainly divided into a solid electrolyte, a liquid electrolyte and a gel electrolyte. During use, the first transparent conductive film 111 and/or the second transparent conductive film 121 supplies electrons, and the electrolyte layer 14 supplies ions to the electrochromic layer 13, such the ions enter into the crystal lattice to cause a coloration effect.

However, both patents of M368088 and M371902 have a common drawback of lacking a necessary electrolyte layer required by electrochromic devices, since ions are not supplied to the electrolyte layer 14 of the electrochromic layer 13, and the electrochromic layer 13 cannot produce the reversible oxidation or reduction to complete the coloration or decoloration successfully, so that the aforementioned patents are not feasible in practical applications. In addition, the transparent conductive films 111, 121 and the electrochromic layer 13 are grid patterned when the grating structure 1 is used as a parallax barrier device, and whose manufacturing process requires a precise alignment for coating, spluttering or etching each laminated layer, such that a hollow area is formed between grids that will affect the overall optical effects including the transmission, the refraction or the reflection of light, and thus the manufacturing process is very complicated. Furthermore, when it is applied for a general 2D display, the image quality may be affected to cause the problem of a color difference or a non-uniform brightness. In addition, the conventional electrochromic material requires greater driving voltage and comes with lower coloration efficiency. Furthermore, after the electrochromic layer 13 is electrically conducted, the coloration effect proximate to the electric connection is faster, and the coloration effect at a position farther from the electric connection is slower, and thus resulting in a non-uniform coloration.

In view of the aforementioned shortcomings of the prior art, the inventor of the present invention developed a grating structure of a 2D/3D switching display device that adopts a solution type electrochromic material and uses an inorganic material to produce an isolating element for isolating the grating structure formed by the solution type electrochromic material. With the innovative design of the conductive wire layer, the invention can improve the speed and uniformity of the coloration/decoloration significantly.

### SUMMARY OF THE INVENTION

Therefore, it is a primary objective of the present invention to provide a grating structure of a 2D/3D switching display device that uses a conductive wire layer disposed around the external periphery of one of the transparent conductive films, accelerates the conduction speed of current and improve the efficiency and uniformity of coloration of the solution type electrochromic material.

Another objective of the present invention is to provide a grating structure of a 2D/3D switching display device capable of enhancing the cladding of the conductive wire layer disposed on the transparent conductive films to prevent the conductive wire layer from falling off.

A further objective of the present invention is to provide a grating structure of a 2D/3D switching display device for improving the property of resisting an organic solvent of the isolating element of the grating structure in order to extend the life of the display device.

To achieve the foregoing objectives, the present invention provides a grating structure of a 2D/3D switching display device, comprising: a first transparent substrate; a first transparent conductive film, disposed on a side surface of the first transparent substrate; a second transparent substrate; a second transparent conductive film, disposed on a side surface of the second transparent substrate and arranged with an interval apart on a side of the first transparent conductive film, such that a potential difference is produced between the first transparent conductive film and the second transparent conductive film; a solution type electrochromic material, disposed between the first transparent conductive film and the second transparent conductive film, for producing coloration according to the electric conduction of the first transparent conductive film and the second transparent conductive film; an isolating element, installed on a surface of the second transparent conductive film, and made of an inorganic material, such that the isolating element is disposed between the first transparent conductive film and the second transparent conductive film for isolating the solution type electrochromic material; and a conductive wire layer, disposed on a lateral periphery of the first transparent conductive film and/or the second transparent conductive film, such that after an electric power is passed through, the conductive wire layer and the solution type electrochromic material are electrically conducted. With the conductive wire layer having a low resistance, the conduction speed of current can be increased, and the conductive wire layer disposed at the periphery can shorten the distance for discharging electricity from the periphery to the center, so as to improve the efficiency and uniformity of the coloration.

Wherein, the solution type electrochromic material is made by mixing and dissolving at least one inorganic electrochromic material and at least one organic electrochromic material into a solvent. The inorganic electrochromic material is an inorganic derivative selected from the collection of an oxide, a sulfide, a chloride and a hydroxide of a transition element. The transition element is one selected from the collection of a scandium subgroup (IIIB), a titanium subgroup (IVB), a chromium subgroup (VIB), a manganese subgroup (VIIB), an iron series (VIII), a copper subgroup (IB), a zinc subgroup (IIB), and a platinum series (VIII). The inorganic electrochromic material is an inorganic derivative selected from the collection of an oxide, a sulfide, a chloride and a hydroxide of a halogen group (VIIA), an oxygen group (VIA), a nitrogen group (VA), a carbon group (IVA), a boron group (IIIA), an alkali earth metal group (IIA) and an alkali metal group (IA). The inorganic electrochromic material is one selected from the collection of ferrous chloride (FeCl₂), ferric trichloride (FeCl₃), titanium trichloride (TiCl₃), titanium tetrachloride (TiCl₄), bismuth chloride (BiCl₃), copper chloride (CuCl₂) and lithium bromide (LiBr). The organic electrochromic material is a redox indicator, a pH indicator, or an organic compound. The solvent is one selected from the collection of dimethyl sulfoxide [(CH₃)₂SO], propylene carbonate (C₄H₆O₃), water (H₂O), γ-butyrolactone, acetonitrile, propionitrile, benzonitrile, glutaronitrile, methylglutaronitrile, 3,3′-oxy-2-propionitrile, hydroxyl propionitrile, dimethyl-formamide, N-methyl pyrrolidone, sulfolane, and 3-methyl sulfolane.

Wherein, the solution type electrochromic material is made by dissolving an organic electrochromic material into a solvent, and the organic electrochromic material is viologen.

Wherein, the isolating element is silicon dioxide (SiO₂).

Wherein, the conductive wire layer is made of a metal conductive wire, or the conductive wire layer is composed of a first cladding layer, a conductive layer, and a second cladding layer stacked on one another.

When the present invention is used, the conductive wire layer disposed around the external side (or internal side) of one or two of the transparent conductive films and the conductive wire layer having a low resistance can accelerate the conduction speed of the current between the two transparent conductive films and discharge the electricity from the periphery towards the center uniformly, such that the efficiency and uniformity of the coloration of the solution type electrochromic material can be improved significantly. In addition, the present invention uses the first cladding layer of the conductive wire layer to increase the cladding property with the transparent conductive films, and the conductive layer can be attached onto the first cladding layer more easily. Finally, the second cladding layer is used to cover the conductive layer, such that the whole conductive wire layer can be attached onto the transparent conductive film more easily and securely to prevent the conductive wire layer from falling off during use.

To improve the electric conductivity of the first transparent conductive film and/or the second transparent conductive film, the first transparent substrate and/or the second transparent substrate further includes a transparent conductive metal film formed thereon and covered onto the first transparent conductive film and/or the second transparent conductive film, and the transparent conductive metal film is a thin film made of a nano metal material, and the nano metal material is one selected from the collection of nano copper, nano silver, and silver nanotube.

### BRIEF DESCRIPTION OF THE DRAWINGS

FIG. 1 is a schematic view of a conventional grating structure;

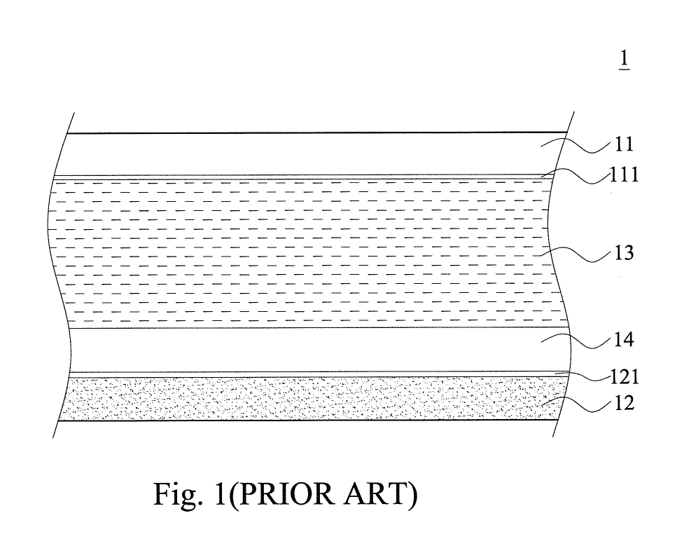

FIG. 2 is an exploded view of a first preferred embodiment of the present invention;

FIG. 3 is a cross-sectional view of an assembly in accordance with a first preferred embodiment of the present invention;

FIG. 4 is a cross-sectional view of a second preferred embodiment of the present invention;

FIG. 5 is a cross-sectional view of a third preferred embodiment of the present invention;

FIG. 6 is a cross-sectional view of a fourth preferred embodiment of the present invention;

FIG. 7 is another cross-sectional view of the first preferred embodiment of the present invention; and

FIG. 8 is another cross-sectional view of the second preferred embodiment of the present invention.

### DETAILED DESCRIPTION OF THE PREFERRED EMBODIMENTS

To make it easier for our examiner to understand the technical contents of the present invention, preferred embodiments together with related drawings are used for the detailed description of the present invention as follows.

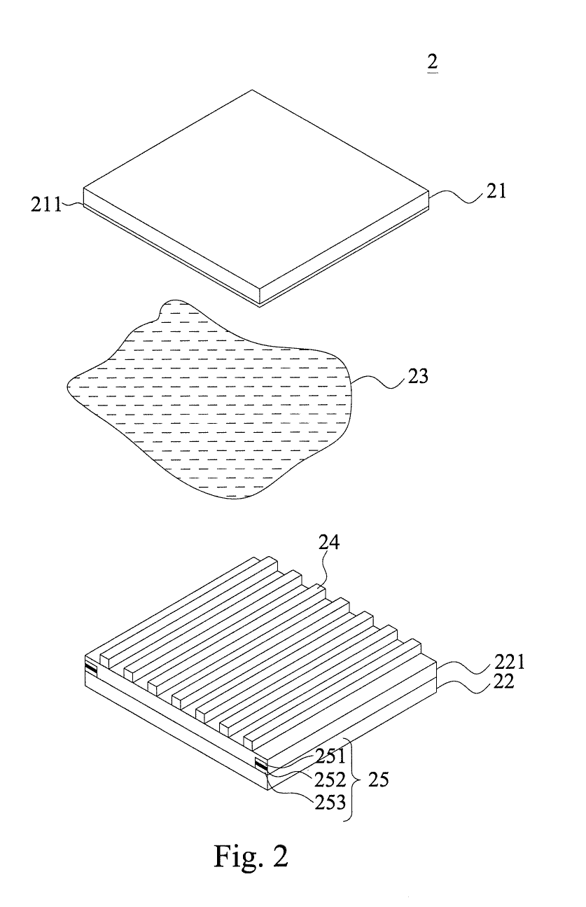

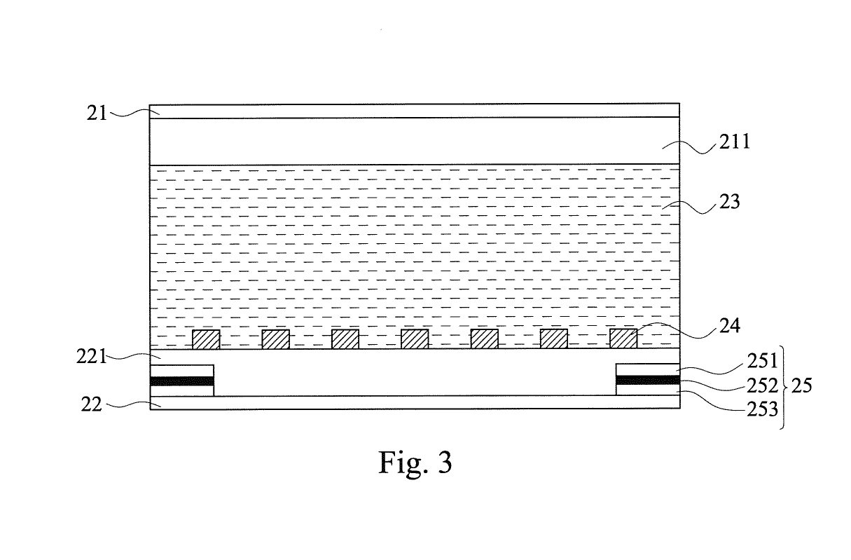

With reference to FIGS. 2 and 3 for an exploded view and a cross-sectional view of an assembly in accordance with a first preferred embodiment of the present invention respectively, a grating structure of a 2D/3D switching display device 2 of the present invention comprises a first transparent substrate 21, a first transparent conductive film 211, a second transparent substrate 22, a second transparent conductive film 221, a solution type electrochromic material 23, an isolating element 24 and a conductive wire layer 25.

The first transparent conductive film 211 and the second transparent conductive film 221 are used together with the first transparent substrate 21 and the second transparent substrate 22, and the second transparent conductive film 221 is disposed with an interval apart on a side of the first transparent conductive film 211, such that a potential difference is produced between the first transparent conductive film 211 and the second transparent conductive film 221, wherein the first transparent conductive film 21 and the second transparent conductive film 22 are made of an impurity-doped oxide selected from the collection of indium tin oxide (ITO), indium zinc oxide (IZO), aluminum-doped ZnO (AZO) and antimony tin oxide (ATO) or a conductive polymer material selected from the collection of carbon nanotube and poly-3,4-ethylenedioxythiophene (PEDOT); preferably the indium tin oxide (ITO) is adopted, since it has good light transmittance and high electric conductivity that can be used as the two conductive electrodes of the present invention. The first transparent substrate 21 and the second transparent substrate 22 are made of plastic, polymer plastic, glass, or a plastic polymer selected from the collection of resin, polyethylene terephthalate (PET), polycarbonate (PC), polyethylene (PE), polyvinyl chloride (PVC), polypropylene (PP), polystyrene (PS) and polymethylmethacrylate (PMMA) and any mixture of the above.

The solution type electrochromic material 23 is filled between the first transparent conductive film 211 and the second transparent conductive film 221, and provided for producing a color change according to the electric conduction of the first transparent conductive film 211 and the second transparent conductive film 221. In addition, the solution type electrochromic material 23 is made by mixing and dissolving at least one inorganic electrochromic material and at least one organic electrochromic material into a solvent, wherein the inorganic electrochromic material is an inorganic derivative selected from the collection of an oxide, a sulfide, a chloride and a hydroxide of a transition element, and the transition element is one selected from the collection of a copper subgroup (IB), a zinc subgroup (IIB), a scandium subgroup (IIIB), a titanium subgroup (IVB), a vanadium subgroup (VB), a chromium subgroup (VIB), a manganese subgroup (VIIB), an iron series (VIIIB) and a platinum series (VIIIB of the fifth or sixth period) ; and the inorganic electrochromic material is an inorganic derivative selected from the collection of an oxide, a sulfide, a chloride and a hydroxide of a halogen group (VIIA), an oxygen group (VIA), a nitrogen group (VA), a carbon group (VIA), a boron group (IIIA), an alkali earth metal group (IIA), and an alkali metal group (IA), or the inorganic electrochromic material is one selected from the collection of ferrous chloride (FeCl₂), ferric trichloride (FeCl₃), titanium trichloride (TiCl₃), titanium tetrachloride (TiCl₄), bismuth chloride (BiCl₃), copper chloride (CuCl₂) and lithium bromide (LiBr). The organic electrochromic material is a redox indicator, a pH indicator or an organic compound, wherein the redox indicator is one selected from the collection of methylene blue (C₁₆H₁₈ClN₃S·3H₂O), viologen, N-phenyl-o-anthranilic acid (C₁₃H₁₁NO₂), sodium diphenylamine sulfonate (C₁₂H₁₀NNaO₃S), Dichloroindophenol Sodium (C₁₂H₆C₁₂NNaO₂), and N-N′-diphenylbenzidine (C₂₀H₂₀N₂); and the pH indicator is variamine blue B diazonium salt (C₁₃H₁₂ClN₃O), or the organic compound is one selected from the collection of 7,7,8,8-tetracyanoquinodimethane and ferrocene [Fe(C₅H₅)₂], and the solvent for preparing the solution type electrochromic material 23 is one selected from the collection of dimethyl sulfoxide [(CH₃)₂SO], propylene carbonate (C₄H₆O₃), water (H₂O), γ-butyrolactone, acetonitrile, propionitrile, benzonitrile, glutaronitrile, methylglutaronitrile, 3,3′-oxy-2-propionitrile, hydroxyl propionitrile, dimethyl-formamide, N-methyl pyrrolidone, sulfolane, and 3-methyl sulfolane. Therefore, the solution type electrochromic material 23 uses the complementary effect of the organic electrochromic material and the inorganic electrochromic material to concurrently provide the redox feature, and the transparent conductive element supplies electrons, such that the valence of ions of the electrochromic material can be changed for producing a coloration by the mobility and transfer of electrons. Compared with the conventional coloration mechanism of the electrochromic material by the concurrent intercalation and de-intercalation of electrons and ions, the driving method of the present invention provides a quick and uniform coloration with the features of a smaller driving voltage and a longer lifespan. To clearly illustrate the principle of the coloration of the liquid electrochromic element, ferrous chloride (FeCH in the iron series (VIIIB) and methylene blue are used for example, and dimethyl sulfoxide (DMSO) is used as the solvent to produce an electrochromic solution of a complementary system. Ferrous chloride crystal particles are in blue color (since Fe²⁺ is blue), and the oxidized surface is in a reddish brown color (since Fe³ is light yellow). If ferrous chloride is dissolved in a solvent, Fe²⁺ will be oxidized to form Fe³⁺, the solvent will become light yellow. The first transparent conductive film 211 and the second transparent conductive film 221 supply electrons, such that when methylene blue molecules approaching the transparent conductive film obtain electrons to produce a reduction, the methylene blue becomes a free radical, and when the external voltage is removed, Fe³⁺ and the methylene blue free radical have different electric potentials (or the methylene blue free radical has a lower electric potential than that of Fe³⁺), and electrons will be transmitted from the methylene blue free radical to Fe³⁺, so that the light yellow Fe³⁺ is reduced to the blue Fe²⁺, and the solution type electrochromic material 23 changes its color from light yellow to blue due to the change of valence by reduction, so as to achieve a dark color change effect to produce a parallax barrier. If the electrons of the first transparent conductive film 211 and the second transparent conductive film 221 are short-circuited or loaded by reverse voltage, the valence is changed due to the oxidation of the solution type electrochromic material 23 to change the color from blue to light yellow to achieve the decoloration effect.

The solution type electrochromic material 23 can be made by dissolving an organic electrochromic material into a solvent.

Wherein, if the solution type electrochromic material 23 is made by dissolving an organic electrochromic material into a solvent, the organic electrochromic material of a preferred embodiment is viologen, wherein the viologen has different colors due to the length of carbon chain of the R substitute radical or different structures, and R substitute radical can be methyl, ethyl, propyl, butyl, pentyl, hexyl, heptyl, octyl, iso-pentyl, or benzyl radical, and the viologen is one selected from the collection of 1,1′-dimethyl-4,4′-bipyridinium dichloride hydrate (MV), 1,1′-diheptyl-4,4′-bipyridinium dibromide (HV), 1,1′-dibenzyl-4,4′-bipyridinium dichloride hydrate (BV), 1,1′-bis(2,4-dinitrophenyl) -4,4′-bipyridinium dichloride, 1,1′-di-n-octyl-4,4′-bipyridinium dibromide, octyl, 1,1′-diphenyl-4,4′-bipyridinium dichloride and 4,4′-bipyridyl.

The isolating element 24 is disposed on a side of the second transparent conductive film 221 and grid patterned. In general, the life of the isolating element made of a photoresist material may be shortened in the solution type electrochromic material 23 since the organic photoresist material is dissolved in an organic solvent easily. The isolating element 24 of the present invention is made of an inorganic material, which is silicon dioxide (SiO₂) adopted in this preferred embodiment, and the isolating element 24 is disposed between the first transparent conductive film 211 and the second transparent conductive film 221 for isolating the solution type electrochromic material 23, such that the solution type electrochromic material 23 is filled and disposed in gaps of the grid patterns of the isolating element 24. After the electric conduction, the solution type electrochromic material 23 will have the coloration or decoloration effect, such that the isolating element 24 and the solution type electrochromic material 23 produce a parallax barrier for switching the display effect of 2D/3D images.

The conductive wire layer 25 is disposed on a lateral periphery of the second transparent substrate 22 as shown in the figure, wherein a conductive wire layer 25 is formed around the periphery of the second transparent substrate 22, and then a second transparent conductive film 221 is laid on a surface of the second transparent substrate 22, and the second transparent conductive film 221 is covered onto a surface of the conductive wire layer 25, wherein the conductive wire layer 25 is a metal or an alloy selected from the collection of aluminum (Al), silver (Ag), copper (Cu), gold (Au), platinum (Pt) and their alloys. In addition, the conductive wire layer 25 is composed of a first cladding layer 251, a conductive layer 252 and a second cladding layer 253 stacked on one another, and the first cladding layer 251 and the second cladding layer 252 of the conductive wire layer 25 are made of a metal with a good cladding property such as molybdenum (Mo), titanium (Ti), cobalt (Co), chromium (Cr) and their alloys, wherein the first cladding layer 251 is provided for improving the adhesive effect of the second transparent substrate 22, and the second cladding layer 253 is provided for improving the cladding and protection of the conductive layer 252 to prevent it from falling off during use, and the conductive layer 252 is made of a good conductive metal such as aluminum (Al), silver (Ag), copper (Cu), gold (Au), platinum (Pt) and their alloys, so that the conductive wire layer 25 has a much lower resistance than the transparent conductive films to improve the conduction speed of current, so as to achieve the effect of enhancing the speed and uniformity of the coloration of the solution type electrochromic material 23. In a preferred embodiment, the conductive wire layers 25 are sequentially arranged in a Cr/Al/Cr or Mo/Al/Mo configuration.

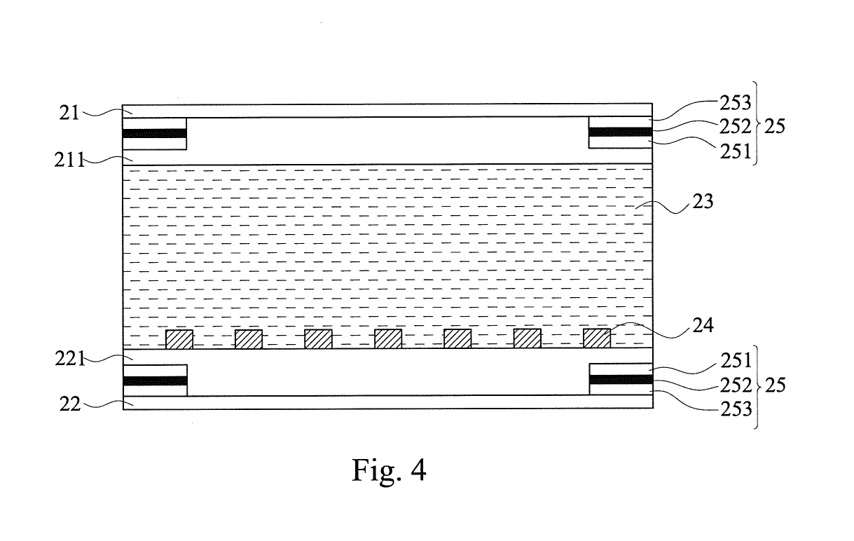

With reference to FIG. 4 for another schematic view of a second preferred embodiment of the present invention, the structure of the second preferred embodiment is substantially the same as that of the first preferred embodiment, except that a conductive wire layer 25 is formed on a lateral periphery of the first transparent substrate 21, and the conductive wire layer 25 is made of a metal or an alloy, or formed by stacking a first cladding layer 251, a conductive layer 252 and a second cladding layer 253 on one another, and the manufacturing process is the same as described above, wherein the conductive wire layer 25 is formed around the first transparent substrate 21 first, and then a first transparent conductive film 211 is laid on a surface of the first transparent substrate 21 and covered onto a surface of the conductive wire layer 25. Compared with the first preferred embodiment, the second preferred embodiment can conduct electric current to the surfaces of the first and second transparent conductive films 211, 221 more quickly to improve the efficiency of the coloration of the solution type electrochromic material 23 significantly, so as to achieve the effects of a quick switch of the 2D/3D display and a uniform coloration.

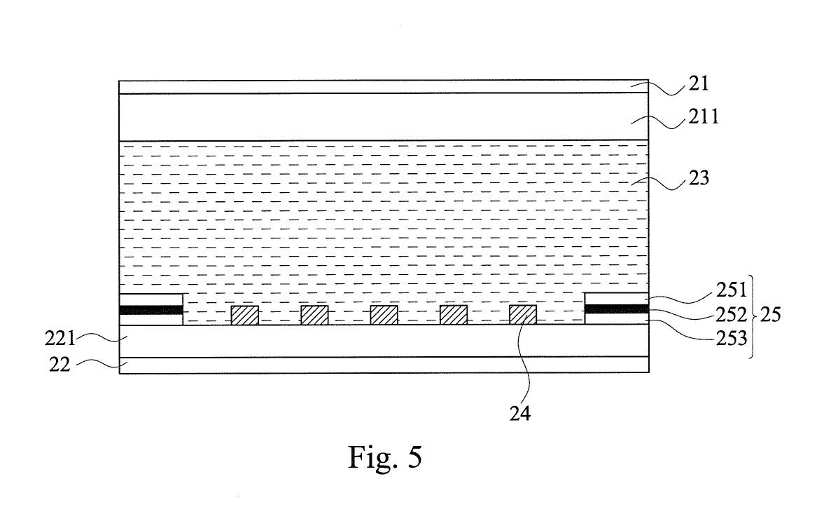

With reference to FIG. 5 for a third preferred embodiment of the present invention, the difference between this preferred embodiment and the first preferred embodiment resides on that the sequence of the manufacturing procedures for the conductive wire layer 25 and the second transparent conductive film 221 are switched. In other words, the second transparent conductive film 221 is formed on the surface of the second transparent substrate 22 first, and then the conductive wire layer 25 is formed around the periphery of the surface of the second transparent conductive film 221. Similar to the first preferred embodiment, the conductive wire layer 25 can be made of a metal or an alloy, or produced by stacking a first cladding layer 251, a conductive layer 252 and a second cladding layer 253 on one another.

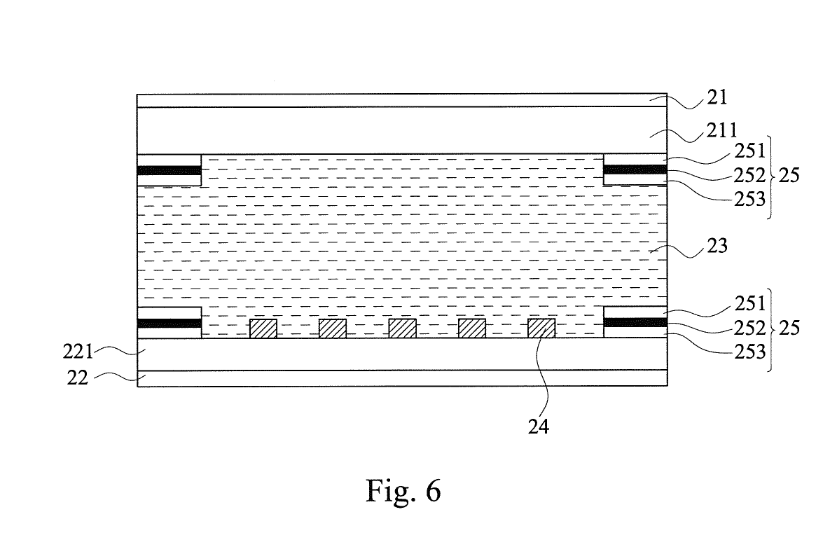

With reference to FIG. 6 for a fourth preferred embodiment of the present invention, the difference of this preferred embodiment from the third preferred embodiment resides on that this preferred embodiment further comprises a conductive wire layer 25 disposed on a surface of the first transparent substrate 21, wherein a first transparent conductive film 211 is formed on a lateral side of the first transparent substrate 21 first, and then a conductive wire layer 25 is disposed around the of the transparent conductive film 211, such that the conduction speed of current of the first and second transparent conductive films 211, 221 can be increased significantly by the conductive wire layers 25.

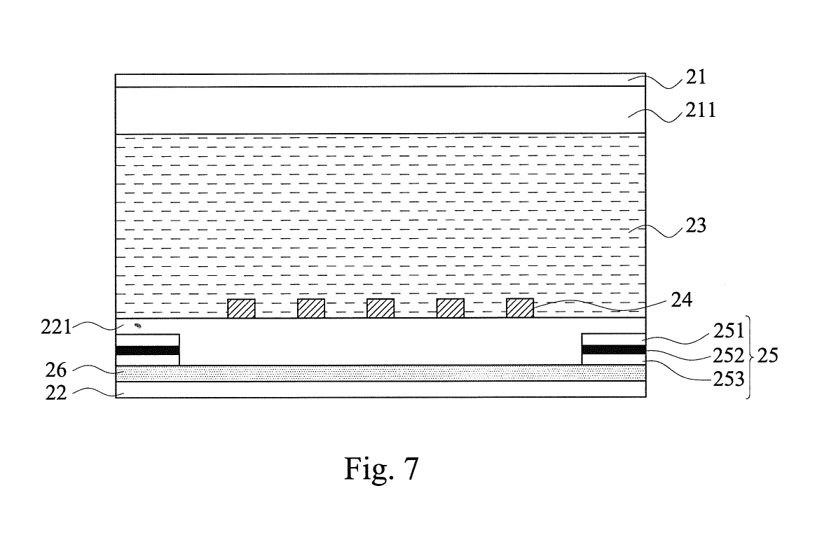

With reference to FIG. 7 for another schematic view of a first preferred embodiment of the present invention, a transparent conductive metal film 26 is further formed on a side surface of the first transparent substrate 21 to improve the electric conduction of the first transparent conductive film 211, wherein the transparent conductive metal film is a thin film made of a nano metal material, and the nano metal material of the transparent conductive metal film 26 is distributed on the thin film layer in a mesh form or a uniformity of maximum entropy. It is noteworthy to point out that the nano metal material is one selected from the collection of nano copper, nano silver and silver nanotube, and the transparent conductive metal film 26 is a transparent film with a thickness controlled below 350 nm, so that the transparent conductive metal film 26 has the electric conductivity of a metal without affecting the light transmittance. Compared with the first exemplary of the first preferred embodiment, this exemplary with the transparent conductive metal film 26 increases a current conduction speed of the first transparent conductive film 211.

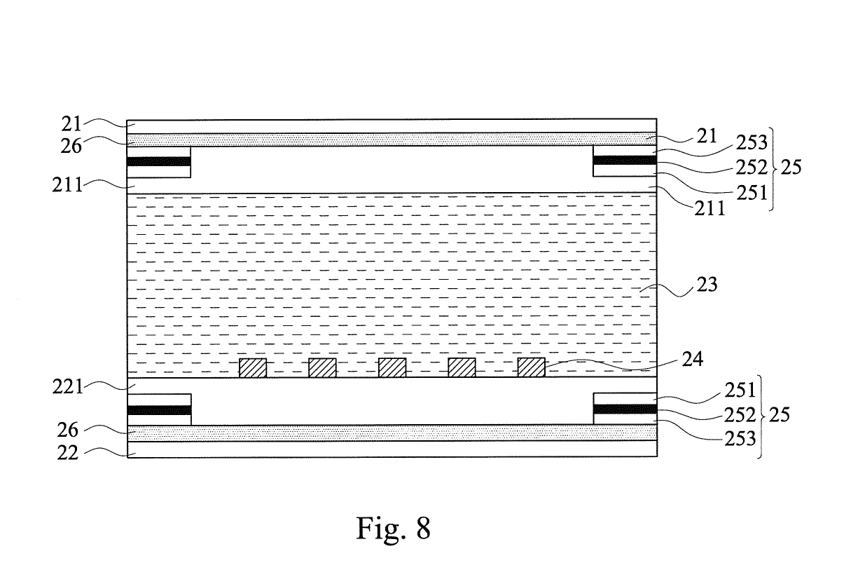

With reference to FIG. 8 for another exemplary of the second preferred embodiment of the present invention, a transparent conductive metal film 26 is further formed on a side surface of the second transparent substrate 22, and the material, thickness and function are the same as those described above, and thus will not be described here again.

In addition, the third and fourth preferred embodiments of the present invention also have a transparent conductive metal film 26 (not shown in the figure) formed on the surface of the first transparent substrate 21 and/or the second transparent substrate 22, and the first transparent conductive film 211 and/or the second transparent conductive film 221 are provided for achieving a better electric conduction. It is noteworthy to point out that the conductive wire layer 25, the transparent conductive metal film 26 and the first transparent conductive film 211 (or the second transparent conductive film 221) are stacked on one another. The stacking sequence is not limited to those of the foregoing preferred embodiments, but the sequence can be switched. In the present invention, the conductive wire layer 25 and the transparent conductive metal film 26 are used to enhance the overall load conduction speed and uniformity.

In summation, when the grating structure of a 2D/3D switching display device 2 of the present invention is used, the conductive wire layer 25 disposed around the external side (or the internal side) of the first transparent conductive film 211 and/or the second transparent conductive film 221 or the transparent conductive metal film 26 is provided for improving the coloration efficiency of the solution type electrochromic material 23 to achieve a quick switch of the 2D/3D display effect. In addition, the first cladding layer 251 of the conductive wire layer 25 improves the cladding with the first transparent substrate 21, the first transparent conductive film 211 or the second transparent substrate 22, and the second transparent conductive film 221, such that the conductive layer 252 can be attached onto the first cladding layer 251 easily, and finally the second cladding layer 252 is used to cover the conductive layer 253, such that the whole conductive wire layer 25 can be attached onto the transparent substrates 21, 22 or the transparent conductive films 211, 221 more easily and securely, so as to prevent the conductive wire layer 25 from peeling off during use.

While the invention has been described by means of specific embodiments, numerous modifications and variations including the material, size or shape of the transparent conductive films or the preparation method and proportion of the solution type electrochromic material could be made thereto by those generally skilled in the art without departing from the scope and spirit of the invention set forth in the claims.

What is claimed is:

1. A grating structure of a 2D/3D switching display device, comprising:
a first transparent substrate;
a first transparent conductive film, disposed on a side surface of the first transparent substrate;
a second transparent substrate;
a second transparent conductive film, disposed on a side surface of the second transparent substrate, and with an interval apart on a side of the first transparent conductive film, such that a potential difference is produced between the first transparent conductive film and the second transparent conductive film;
a solution type electrochromic material, disposed between the first transparent conductive film and the second transparent conductive film, for producing a color change according to the electric conduction of the first transparent conductive film and the second transparent conductive film;
an isolating element, disposed on a side of the second transparent conductive film, and made of an inorganic material, such that the isolating element is situated between the first transparent conductive film and the second transparent conductive film for isolating the solution type electrochromic material; and
a conductive wire layer, disposed on a lateral periphery of the first transparent conductive film and/or the second transparent conductive film, such that after an electric power is connected, the conductive wire layer and the solution type electrochromic material are electrically conducted to accelerate a current conduction speed to improve the efficiency and uniformity of a coloration of the solution type electrochromic material.

2. The grating structure of a 2D/3D switching display device as recited in claim 1, wherein the first transparent conductive film and the second transparent conductive film are made of an impurity-doped oxide selected from the collection of indium tin oxide (ITO), indium zinc oxide (IZO), aluminum-doped ZnO (AZO) and antimony tin oxide (ATO) or a conductive polymer material selected from the collection of carbon nanotube and poly-3,4-ethylenedioxythiophene (PEDOT).

3. The grating structure of a 2D/3D switching display device as recited in claim 1, wherein the solution type electrochromic material is made by mixing and dissolving at least one inorganic electrochromic material and at least one organic electrochromic material into a solvent.

4. The grating structure of a 2D/3D switching display device as recited in claim 3, wherein the inorganic electrochromic material is an inorganic derivative selected from the collection of an oxide, a sulfide, a chloride and a hydroxide of a transition element.

5. The grating structure of a 2D/3D switching display device as recited in claim 4, wherein the transition element is one selected from the collection of a scandium subgroup (IIIB), a titanium subgroup (IVB), a vanadium subgroup (VB) , a chromium subgroup (VIB), a manganese subgroup (VIIB), an iron series (VIII), a copper subgroup (IB), a zinc subgroup (IIB), and a platinum series (VIII).

6. The grating structure of a 2D/3D switching display device as recited in claim 3, wherein the inorganic electrochromic material is an inorganic derivative selected from the collection of an oxide, a sulfide, a chloride, and a hydroxide of a halogen group (VIIA), an oxygen group (VIA), a nitrogen group (VA), a carbon group (IVA), a boron group (IIIA), an alkaline earth metal group (IIA), and an alkaline metal group (IA).

7. The grating structure of a 2D/3D switching display device as recited in claim 3, wherein the inorganic electrochromic material is one selected from the collection of ferrous chloride (FeCl₂), ferric trichloride (FeCl₃), titanium trichloride (TiCl₃), titanium tetrachloride (TiCl₄), bismuth chloride (BiCl₃), copper chloride (CuCl₂) and lithium bromide (LiBr).

8. The grating structure of a 2D/3D switching display device as recited in claim 3, wherein the organic electrochromic material is a redox indicator, a pH indicator, or an organic compound.

9. The grating structure of a 2D/3D switching display device as recited in claim 8, wherein the redox indicator is one selected from the collection of methylene blue (C₁₆H₁₈ClN₃S·3H₂O), viologen, N-phenyl-o-anthranilic acid (C₁₃H₁₁NO₂), sodium diphenylamine sulfonate (C₁₂H₁₀NNaO₃S), Dichloroindophenol Sodium (C₁₂H₆C₁₂NNaO₂), and N-N′-Diphenylbenzidine (C₂₀H₂₀N₂).

10. The grating structure of a 2D/3D switching display device as recited in claim 8, wherein the pH indicator is variamine blue B diazonium salt (C₁₃H₁₂ClN₃O).

11. The grating structure of a 2D/3D switching display device as recited in claim 8, wherein the organic compound is one selected from the collection of 7,7,8,8-tetracyanoquinodimethane and ferrocene [Fe(C₅H₅)₂].

12. The grating structure of a 2D/3D switching display device as recited in claim 3, wherein the solvent is one selected from the collection of dimethyl sulfoxide [(CH₃)₂SO], propylene carbonate (C₄H₆O₃), water (H₂O), γ-butyrolactone, acetonitrile, propionitrile, benzonitrile, glutaronitrile, methylglutaronitrile, 3,3′-oxy-2-propionitrile, hydroxyl propionitrile, dimethyl-formamide, N-methyl pyrrolidone, sulfolane, and 3-methyl sulfolane.

13. The grating structure of a 2D/3D switching display device as recited in claim 1, wherein the solution type electrochromic material is made by dissolving an organic electrochromic material into a solvent.

14. The grating structure of a 2D/3D switching display device as recited in claim 13, wherein the organic electrochromic material is viologen.

15. The grating structure of a 2D/3D switching display device as recited in claim 1, wherein the isolating element is silicon dioxide (SiO₂).

16. The grating structure of a 2D/3D switching display device as recited in claim 1, wherein the conductive wire layer is made of a metal or an alloy.

17. The grating structure of a 2D/3D switching display device as recited in claim 1, wherein the conductive wire layer is comprised of a first cladding layer, a conductive layer and a second cladding layer stacked with each other.

18. The grating structure of a 2D/3D switching display device as recited in claim 17, wherein the first cladding layer and the second cladding layer are made of a metal with a good cladding property selected from the collection of molybdenum (Mo), titanium (Ti), cobalt (Co), chromium (Cr) and an alloy of the above.

19. The grating structure of a 2D/3D switching display device as recited in claim 17, wherein the conductive layer is made of a metal with a good electric conductivity selected from the collection of aluminum (Al), silver (Ag), copper (Cu), gold (Au), platinum (Pt) and an alloy of the above.

20. The grating structure of a 2D/3D switching display device as recited in claim 1, wherein the first transparent substrate and/or the second transparent substrate further comprises a transparent conductive metal film formed on a side surface of the first transparent substrate and/or the second transparent substrate and covered onto the first transparent conductive film and/or the second transparent conductive film.

21. The grating structure of a 2D/3D switching display device as recited in claim 20, wherein the transparent conductive metal film is a thin film made of a nano metal material.

22. The grating structure of a 2D/3D switching display device as recited in claim 21, wherein the nano metal material is one selected from the collection of nano copper, nano silver and silver nanotube.
